(19) United States
(12) Patent Application Publication
(10) Pub. No.: US 2020/0191540 A1
(43) Pub. Date: Jun. 18, 2020

(54) RULER

(71) Applicant: Zhejiang MGS Level Industry Co., Ltd., Jinhua, Zhejiang (CN)

(72) Inventor: Maicy Li, Guangzhou, Guangdong (CN)

(21) Appl. No.: 16/619,210

(22) PCT Filed: Nov. 21, 2017
(86) PCT No.: PCT/CN2017/112135

§ 371 Date: Dec. 4, 2019

(30) Foreign Application Priority Data
Jun. 7, 2017 (CN) 201720657737.X

(51) Int. Cl. G01B 3/04; G01C 9/28

(52) U.S. Cl. CPC G01B 3/04; G01C 9/28

(57) ABSTRACT

The present invention provides a ruler, comprising a first ruler body and a second ruler body, wherein the first ruler body and the second ruler body are connected in a relatively rotatable manner to enable both leveled and perpendicular connections of the first ruler body and the second ruler body.

### TECHNICAL FIELD

The invention relates to a ruler, in particular to a ruler used as a measuring tool.

### BACKGROUND ART

A ruler is a measuring tool for detection and alignment of horizontality and verticality of an object, and the levelness of the object can be conveniently measured. However, the existing ruler can only provide measurement in a single direction and only has one function. If it is required to derive a corresponding vertical line/plane from the already located horizontal line/plane, one needs to perform measurement for a second time with the aid of other tools.

### SUMMARY OF THE INVENTION

In order to solve the above problems, the present invention provides a ruler which enables user to locate and measure a horizontal plane and a vertical plane at once, and the ruler can be applied as either a leveling instrument in industrial technical fields or a stationery ruler for students.

The present invention provides a ruler, comprising a first ruler body and a second ruler body,

wherein the first ruler body and the second ruler body are connected in a relatively rotatable manner to enable both leveled and perpendicular connections of the first ruler body and the second ruler body.

Further, the first ruler body comprises a first surface and a second surface which are parallel to each other, and the second ruler body comprises a third surface and a fourth surface which are parallel to each other, wherein a long side of the first surface has a length smaller than or equal to that of a long side of the second surface, and a long side of the third surface has a length larger than or equal to that of a long side of the fourth surface.

Further, when the first ruler body and the second ruler body are in leveled connection, the first surface and the third surface are in leveled connection and form an included angle of 180 degrees, and the second surface and the fourth surface are in leveled connection and form an included angle of 180 degrees; and when the first ruler body and the second ruler body are in perpendicular connection, the first surface and the fourth surface are in perpendicular connection and form an included angle of 90 degrees, and the second surface and the third surface are in perpendicular connection and form an included angle of 90 degrees.

Further, the first ruler body comprises a first connecting surface intersecting with both the first surface and the second surface, the second ruler body comprises a second connecting surface intersecting with both the third surface and the fourth surface, and the first connecting surface and the second connecting surface are connected by means of an assembly bolt and each is capable of rotating with the other one as a reference surface.

Preferably, the assembly bolt is perpendicular to the first connecting surface and the second connecting surface and is positioned at a geometric center point of the first connecting surface or the second connecting surface, and the first connecting surface and the second connecting surface rotate with the assembly bolt as an axis.

Further, the first ruler body comprises a first connecting surface intersecting with both the first surface and the second surface, the second ruler body comprises a second connecting surface intersecting with both the third surface and the fourth surface, and the first connecting surface and the second connecting surface are connected by attraction of magnets and each is capable of rotating with the other one as a reference surface; wherein the magnets are positioned at geometric center points of the first connecting surface and the second connecting surface, and the first connecting surface and the second connecting surface rotate about the geometric center points.

Further, the first connecting surface and the second surface form an included angle of 45 degrees, and the second connecting surface and the third surface form an included angle of 45 degrees.

Further, when the first ruler body and the second ruler body are in leveled or perpendicular connection, the first connecting surface overlaps the second connecting surface.

Preferably, the first ruler body and the second ruler body are each provided with at least one bubble tube.

According to the invention, the needs for judging a horizontal plane of an object and providing a calibration reference are met, and a user can perform vertical location and measurement relative to the horizontal plane at the same time.

### BRIEF DESCRIPTION OF THE DRAWINGS

FIG. 1 is a schematic view showing a ruler in a leveled connection state according to the present invention; and

FIG. 2 is a schematic view showing a ruler in a perpendicular connection state according to the present invention.

### DETAILED DESCRIPTION OF THE INVENTION

Embodiments of the ruler of the present invention will be described in detail below with reference to the accompanying drawings, but the present invention is not limited to these embodiments.

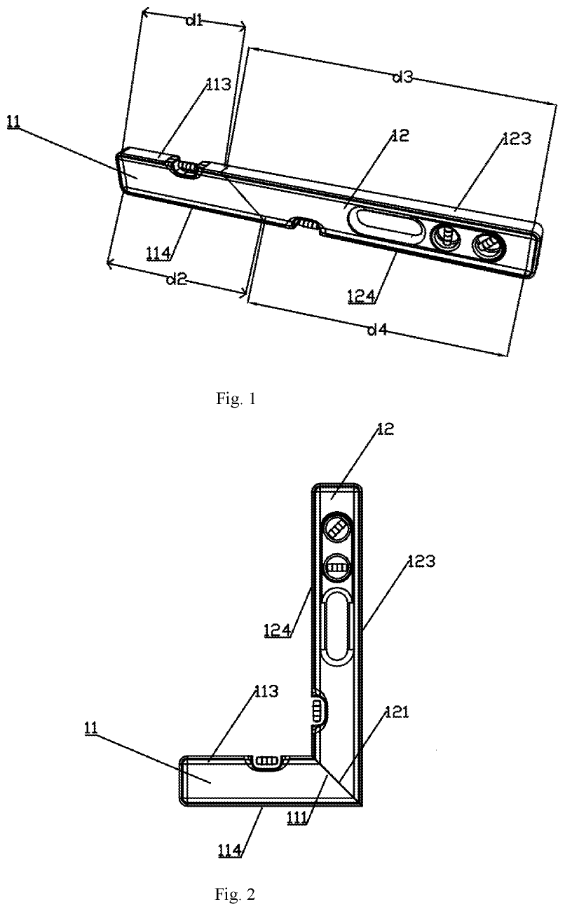

As shown in FIGS. 1 and 2, the ruler of the present invention comprises a first ruler body 11 and a second ruler body 12, the first ruler body 11 comprises a first surface 113 and a second surface 114 which are parallel to each other, and the second ruler body 12 comprises a third surface 123 and a fourth surface 124 which are parallel to each other, wherein a long side of the first surface 113 has a length d1 smaller than or equal to a length d2 of a long side of the second surface 114, and a long side of the third surface 123 has a length d3 larger than or equal to a length d4 of a long side of the fourth surface 124. Preferably, the first ruler body 11 and the second ruler body 12 are each provided with at least one bubble tube, wherein the bubble tube is internally provided with a bubble, and during measurement, it is indicated that the ruler is horizontal if the bubble is at the center of the bubble tube, otherwise, the ruler needs angular adjustment.

The first ruler body 11 and the second ruler body 12 are connected in a relatively rotatable manner so that the first ruler body 11 and the second ruler body 12 can switch between a leveled connection state and a perpendicular connection state. In the leveled connection state, the first ruler body 11 and the second ruler body 12 are assembled into a straight ruler. The first surface 113 of the first ruler body 11 and the third surface 123 of the second ruler body form an included angle of 180 degrees, the second surface 114 of the first ruler body 11 and the fourth surface 124 of the second ruler body form an included angle of 180 degrees; and in the perpendicular connection state, the first surface 113 of the first ruler body 11 and the fourth surface 124 of the second ruler body are in perpendicular connection and form an included angle of 90 degrees, and the second surface 114 of the first ruler body and the third surface 123 of the second ruler body are in perpendicular connection and form an included angle of 90 degrees.

Specifically, the first and second rule bodies 11 and 12 are connected through respective first and second connecting surfaces 111 and 121, the first connecting surface 111 intersects with the first and second surfaces, the second connecting surface 121 intersects with the third and fourth surfaces, and the first connecting surface 111 and the second connecting surface 121 may be connected in various ways, such as by means of an assembly bolt or by attraction of magnets, etc.

If the first connecting surface 111 and the second connecting surface 121 are connected by means of an assembly bolt, the assembly bolt is perpendicular to the first connecting surface 111 and the second connecting surface 121, and is positioned at a geometric center of the first connecting surface 111, or the assembly bolt may be positioned at a geometric center point of the second connecting surface 121, and the first connecting surface 111 and the second connecting surface 121 rotate with the assembly bolt as an axis. The assembly bolt may have a structure of a screw with a washer and a nut or a structure of a rivet with a washer, which is not particularly limited, as long as the connection between the first connecting surface and the second connecting surface can be achieved and each of the two connecting surfaces is allowed to rotate with the other one as a reference surface. Taking the structure of the screw and the nut as an example, for instance, the screw may be disposed on the first connecting surface, the nut may be disposed on the second connecting surface, and the washer may be added at a joint of the screw and the nut so that the screw and the nut can rotate relative to each other without separating from each other.

Or the first connecting surface and the second connecting surface may be connected by means of magnets, a concave point (with a magnet button) is disposed at the geometric center of the first connecting surface, and a convex point (with a magnet button) is disposed at the geometric center of the second connecting surface, so that it is ensured that the first connecting surface and the second connecting surface always rotate about the geometric centers of the connecting surfaces.

According to the present invention, both the first connecting surface 111 and the second connecting surface 121 are bevel surfaces having an angle of 45 degrees, namely, the first connecting surface 111 and the second surface 114 form an included angle of 45 degrees, and the second connecting surface 121 and the third surface 123 form an included angle of 45 degrees. In addition, an intersection line of the first connecting surface with the first surface is perpendicular to the long side of the first surface, and an intersection line of the first connecting surface with the second surface is also perpendicular to the long side of the second surface; similarly, intersection lines of the second connecting surface with the third surface and the fourth surface are perpendicular to the long side of the third surface and the long side of the fourth surface, respectively. Thus, as shown in FIG. 1, when the first ruler body 11 and the second ruler body 12 are in the leveled connection state, the first connecting surface completely overlaps the second connecting surface, and the first ruler body 11 and the second ruler body 12 are combined into a straight ruler; and as shown in FIG. 2, when the first ruler body 11 and the second ruler body 12 are in the perpendicular connection state, the first connecting surface completely overlaps the second connecting surface, and then the first ruler body 11 is perpendicular to the second ruler body 12.

The ruler provided the present invention can be used as either a leveling ruler for industrial measurement or a stationery ruler for students, the needs for judging a horizontal plane of an object and providing a calibration reference are met, and a user can perform vertical location and measurement relative to the horizontal plane at the same time.

The embodiments described in this specification are merely illustration of implementations of the inventive concepts, and the scope of the invention should not be construed as limited to the specific forms set forth in the embodiments, and equivalent technical means that would occur to one skilled in the art in light of the inventive concepts also fall within the scope of the invention.

1. A ruler, characterized in that: the ruler comprises a first ruler body and a second ruler body,
wherein the first ruler body and the second ruler body are connected in a relatively rotatable manner to enable both leveled and perpendicular connections of the first ruler body and the second ruler body.

2. The ruler of claim 1, characterized in that: the first ruler body comprises a first surface and a second surface which are parallel to each other, and the second ruler body comprises a third surface and a fourth surface which are parallel to each other, wherein a long side of the first surface has a length smaller than or equal to that of a long side of the second surface, and a long side of the third surface has a length larger than or equal to that of a long side of the fourth surface.

3. The ruler of claim 2, characterized in that: when the first ruler body and the second ruler body are in leveled connection, the first surface and the third surface are in leveled connection and form an included angle of 180 degrees, and the second surface and the fourth surface are in leveled connection and form an included angle of 180 degrees; and when the first ruler body and the second ruler body are in perpendicular connection, the first surface and the fourth surface are in perpendicular connection and form an included angle of 90 degrees, and the second surface and the third surface are in perpendicular connection and form an included angle of 90 degrees.

4. The ruler of claim 2, characterized in that: the first ruler body comprises a first connecting surface intersecting with both the first surface and the second surface, the second ruler body comprises a second connecting surface intersecting with both the third surface and the fourth surface, and the first connecting surface and the second connecting surface are connected by means of an assembly bolt and each is capable of rotating with the other one as a reference surface.

5. The ruler of claim 4, characterized in that: the assembly bolt is perpendicular to the first connecting surface and the second connecting surface and is positioned at a geometric center point of the first connecting surface or the second connecting surface, and the first connecting surface and the second connecting surface rotate with the assembly bolt as an axis.

6. The ruler of claim 2, characterized in that: the first ruler body comprises a first connecting surface intersecting with both the first surface and the second surface, the second ruler body comprises a second connecting surface intersecting with both the third surface and the fourth surface, and the first connecting surface and the second connecting surface are connected by attraction of magnets and each is capable of rotating with the other one as a reference surface; wherein the magnets are positioned at geometric center points of the first connecting surface and the second connecting surface, and the first connecting surface and the second connecting surface rotate about the geometric center points.

7. The ruler according to claim 4, characterized in that: the first connecting surface and the second surface form an included angle of 45 degrees, and the second connecting surface and the third surface form an included angle of 45 degrees.

8. The ruler of claim 7, characterized in that: when the first ruler body and the second ruler body are in leveled or perpendicular connection, the first connecting surface overlaps the second connecting surface.

9. The ruler of claim 1, characterized in that: the first ruler body and the second ruler body are each provided with at least one bubble tube.

10. The ruler according to claim 6, characterized in that: the first connecting surface and the second surface form an included angle of 45 degrees, and the second connecting surface and the third surface form an included angle of 45 degrees.

11. The ruler of claim 9, characterized in that: when the first ruler body and the second ruler body are in leveled or perpendicular connection, the first connecting surface overlaps the second connecting surface.
